(19) United States
(12) Patent Application Publication
(10) Pub. No.: US 2016/0350829 A1
(43) Pub. Date: Dec. 1, 2016

(54) SYSTEMS AND METHODS FOR EMBEDDING A GIFT CARD IN A HOST CARD

(71) Applicant: Keverne Monice Denahan, San Francisco, CA (US)

(72) Inventor: Keverne Monice Denahan, San Francisco, CA (US)

(21) Appl. No.: 15/165,450

(22) Filed: May 26, 2016

Related U.S. Application Data
(60) Provisional application No. 62/166,700, filed on May 27, 2015.

(51) Int. Cl. G06Q 30/06; G06Q 20/28; G06Q 10/08

(52) U.S. Cl. CPC G06Q 30/0621; G06Q 10/083; G06Q 20/28

(57) ABSTRACT

A method for producing a custom card. The method includes allowing a user to select a gift card and allowing a user to select a host card. The method also includes combining the host card and the gift card to create a card and delivering the card to the recipient.

### CROSS-REFERENCE TO RELATED APPLICATIONS

This application claims the benefit of and priority to U.S. Provisional Patent Application Ser. No. 62/166,700 filed on May 27, 2015, which application is incorporated herein by reference in its entirety.

### BACKGROUND OF THE INVENTION

Greeting Cards and Postcards are purchased in the millions and given and sent to billions of people annually. In the USA alone more than 7 billion greeting cards are purchased and sent (physical cards and e-cards). Also more than $120 billion in Gift Cards is purchased annually (with the inclusion of Pre-Paid cards that is more than $200 billion annually).

Combining a gift card with a greeting card or a postcard is two distinct operations and products and well known in the existing art. A greeting card is usually purchased and handed or posted to the recipient. A Gift Card as a Gift is usually purchased separately and if desired can be included with the greeting card. Gift Cards have a monetary value, usually on the face of the card. The recipient then uses the Gift Card to redeem an amount of money or a product to the card's face value. Sometimes the card can be redeemed for cash. The process of buying a gift card and giving a gift card are well known processes

Gift Cards can be purchased from the same places that greeting cards and postcards are purchased but again usually two separate purchases. These two separate items are purchased and gifted or given as two separate items even when together. Greeting Cards and Postcards can be purchased either as physical cards or created online. When purchased as a physical item cards are a completed product. When purchased as an online product they can be either sent electronically or printed and then posted.

Accordingly, there is a need in the art to join together into a single entity both a gift card and a greeting card or a gift card and a postcard as the case may be into a single product, created at the same time as a single process. Further, there is a need in the art for gift card designs to be specifically incorporated into a greeting card or post card by printing it directly onto the card itself.

### BRIEF SUMMARY OF SOME EXAMPLE EMBODIMENTS

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter.

One example embodiment includes a method for producing a custom card. The method includes allowing a user to select a gift card and allowing a user to select a host card. The method also includes combining the host card and the gift card to create a card and delivering the card to the recipient.

Another example embodiment includes a method for producing a custom card. The method includes allowing a user to select a gift card and allowing a user to select a host card. The method also includes combining the host card and the gift card to create a card. The method further includes receiving information about the user and receiving information about the recipient. The method additionally includes creating a card ID for the card and delivering the card to the recipient.

Another example embodiment includes a method for producing a custom card. The method includes allowing a user to select a gift card. Allowing the user to select the gift card includes receiving from the user the gift to be represented by the gift card and receiving from the user a design for the gift card. Allowing the user to select the gift card also includes receiving from the user a desired font if the user wants a message to appear on the gift card. The method moreover includes allowing the user to select a host card. Allowing the user to select the host card includes receiving from the user a design for the host card and receiving from the user a desired font if the user wants a message to appear on the host card. The method also includes combining the host card and the gift card to create a card. The method further includes receiving information about the user and receiving information about the recipient. The method additionally includes presenting the card to the user for final approval, creating a card ID for the card and delivering the card to the recipient.

These and other objects and features of the present invention will become more fully apparent from the following description and appended claims, or may be learned by the practice of the invention as set forth hereinafter.

### BRIEF DESCRIPTION OF THE DRAWINGS

To further clarify various aspects of some example embodiments of the present invention, a more particular description of the invention will be rendered by reference to specific embodiments thereof which are illustrated in the appended drawings. It is appreciated that these drawings depict only illustrated embodiments of the invention and are therefore not to be considered limiting of its scope. The invention will be described and explained with additional specificity and detail through the use of the accompanying drawings in which:

FIG. 1 is a flowchart illustrating a method of producing a custom card;

FIG. 2 is a flowchart illustrating a method of allowing a user to select a gift card;

FIG. 3 illustrates an example of an interface that allows a user to create a custom font from his/her handwriting;

FIG. 4 is a flowchart illustrating a method of delivering a completed card to a recipient;

FIG. 5 illustrates an example of a personalized postcard with an embedded gift card; and

FIG. 6 illustrates an example of a suitable computing environment in which the invention may be implemented.

### DETAILED DESCRIPTION OF SOME EXAMPLE EMBODIMENTS

Reference will now be made to the figures wherein like structures will be provided with like reference designations. It is understood that the figures are diagrammatic and schematic representations of some embodiments of the invention, and are not limiting of the present invention, nor are they necessarily drawn to scale.

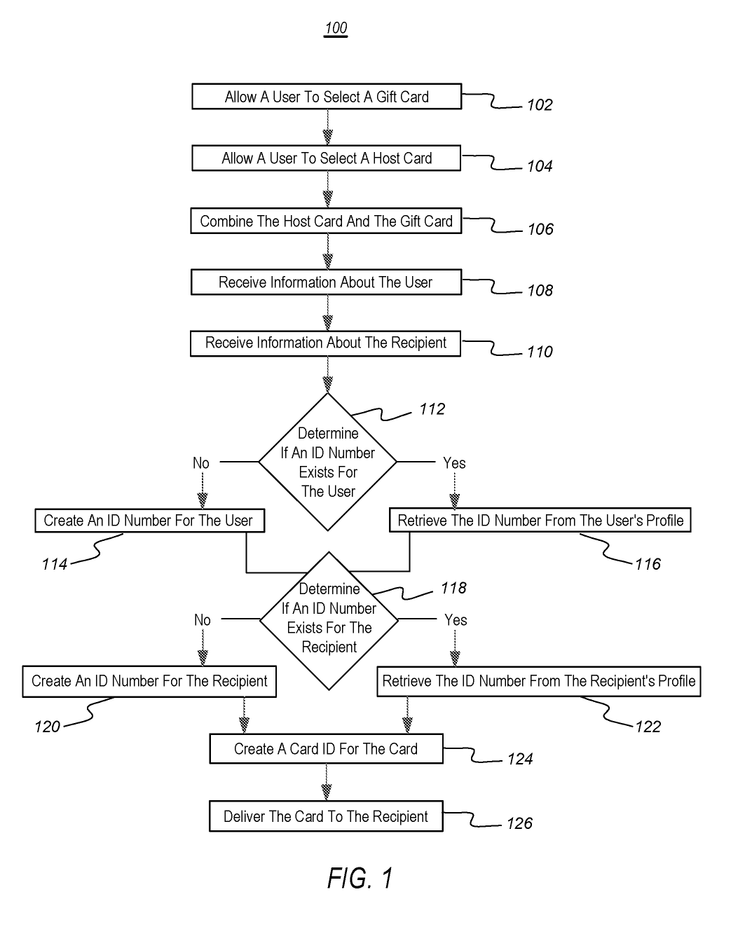

FIG. 1 is a flowchart illustrating a method 100 of producing a custom card. The method 100 allows a user to select both the details and the look of the card. For example, the user can add a custom message or graphic to the card to personalize the card. The card is then delivered to a desired recipient. The method 100 can be implemented in software contained on a device, such as native software on a computer or other electronic device, or contained within a server that speaks to or is connected an electronic device.

FIG. 1 shows that the method 100 can include allowing 102 a user to select a gift card. The card can be a hard card or can be part of a greeting card, post card or any other desired medium. Additionally or alternatively, the gift card can represent a non-monetary gift that will be sent to the user. The gift can be in the form of a gift card, such as store credit to a particular retailer or in the form of a debit card for a set amount, or can be a card representing an actual gift. For example, the gift card can be selected from a retail partner either directly from the retailer or from a third party. E.g., the website allowing a user to create the gift card can also show items from retail partners and/or direct the user to retail partner's website(s).

FIG. 1 moreover shows that the method 100 can include allowing 104 a user to select a host card. The host card can include any desired host for the gift card, such as a greeting card, postcard, letter, or any other desired host. The host card can be selected from templates or entirely designed by the user. Alternatively, the host card may in existence and provided by the user. As used herein “gift card” means the gift card alone, “host card” means the associated host alone, and “card” means the combination of the gift card and host card.

FIG. 1 additionally shows that the method 100 can include combining 106 the host card and the gift card. That is, the host card and the gift card are combined 106 into a single card that can be sent to the recipient. Specifically, the gift card is embedded into the host card. Embedding can occur physically or electronically, as described below.

FIG. 1 also shows that the method 100 can include receiving 108 information about the user. The information can include any information required to identify a user. For example, the information can include the user's name, address, email address, phone number, etc. Alternatively, the information can include a user's login information allowing for retrieval of stored information for the user. I.e., the user can log in to a server or software to access information previously entered.

FIG. 1 further shows that the method 100 can include receiving 110 information about the recipient. For example, the information can include the recipient's name, address, email address, phone number, etc. Alternatively, the information can include a recipient's user id. I.e., if the recipient has used the service previously or if the user has previously sent a card to the recipient then the gift can be sent to the recipient's profile. The profile need not be tied directly to the site through which the card is being purchased. For example, if the process is tied to social media or other programs the information can include the recipient's social medial profile.

FIG. 1 additionally shows that the method 100 can include determining 112 if an ID number exists for the user. The ID number for the user can allow the user's cards (both sent and received) to be associated with the user without giving out any personal information. I.e., the ID number allows the user to create a card for a retailer without the retailer receiving any information that can identify the user outside of the gift card system.

FIG. 1 moreover shows that the method 100 can include creating 114 an ID number for the user if one doesn't exist. For example, if this is the first time that the user has entered his/her information a random string of characters can be generated which is then associated with the user's profile. If an ID does exist, then the ID number can be retrieved 116 from the user's profile. This ID number does not need to be provided to the user.

FIG. 1 also shows that the method 100 can include determining 118 if an ID number exists for the recipient. The ID number for the user can allow the recipient's cards (both sent and received) to be associated with the recipient without giving out any personal information. I.e., the ID number allows the user to create a card for a retailer without the retailer receiving any information that can identify the recipient outside of the gift card system.

FIG. 1 further shows that the method 100 can include creating 120 an ID number for the recipient if one doesn't exist. For example, if this is the first time that the recipient has had his/her information entered a random string of characters can be generated which is then associated with the user's profile. If an ID does exist, then the ID number can be retrieved 122 from the recipient's profile. This ID number does not need to be provided to the recipient.

FIG. 1 additionally shows that the method 100 can include creating 124 a card ID for the card. The card ID allows the card to be replaced if it is damaged or destroyed and/or can allow the user to more easily create cards in the future. I.e., the card ID can be saved to the user's profile to allow him/her to send the same card in the future (either to the same recipient or a different recipient). The card ID can be stored digitally, can be printed on the card or can be given to either the user in some other way (e.g., via text or email). In addition, the card ID allows both the user ID and the recipient ID to be located, if necessary. I.e., the card ID, the user ID and the recipient ID are associated with one another.

FIG. 1 moreover shows that the method 100 can include delivering 126 the card to the recipient. Delivering 126 the card to the recipient can include electronic delivery or physical delivery to the recipient. Specifically, the user can determine how the card should be delivered 126 to the recipient, as described below.

One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

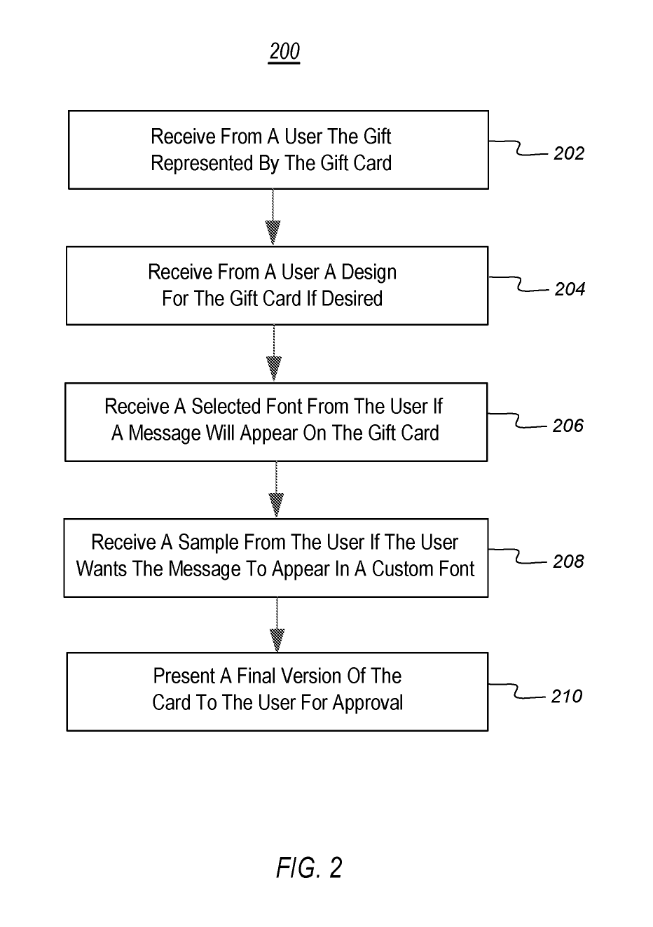

FIG. 2 is a flowchart illustrating a method 200 of allowing a user to select a gift card. In particular, a user may not only select the retailer and amount of the gift card or the gift represented by the gift card but may also select the design of the gift card. That is, the user can be allowed to custom design the gift card to make the gift more personal. One of skill in the art will appreciate that the same method can be followed to allow a user to select a host card; therefore, all steps of FIG. 2 should be considered as also disclosing the selection of a host card and a combination of a host card and gift card.

FIG. 2 shows that the method 200 can include receiving 202 from a user the gift to represented by the gift card. The gift can be an actual gift that is pictured on the gift card, can include an amount to be spent at a retailer, can include a prepaid debit or credit card or can include any other desired gift.

FIG. 2 also shows that the method 200 can include receiving 204 from a user a design for the gift card if desired. For example, if the gift card is for a retailer the user may be able to select from several different gift card designs. In addition, the user may be able to select from predesigned cards or can choose a theme for the gift card. Additionally or alternatively, the user can select a picture or a message to be printed on gift card. For example, the user could, after selecting a pre-paid debit card, select a theme for the gift card, add a picture to the gift card and/or prepare a message to be printed on the gift card. If the user wishes to have a personalized message, the receiving 204 the design from the user can include the text of the message.

FIG. 2 further shows that the method 200 can include receiving 206 a selected font from the user if a message will appear on the gift card. I.e., if the user wishes to have a personalized message on the gift card then he she can select the font of the text along with the text. The font can be from predefined fonts or can include a custom font created for the user, as described below. For example, the user can select from a dropdown menu the option “custom” or otherwise indicate that he/she wants to create a font.

FIG. 2 additionally shows that the method 200 can include receiving 208 a sample from the user if the user wants the message to appear in a custom font. For example, the user can provide a handwriting sample or other sample that shows the desired font. If the sample is handwriting then the user can handwrite the message and upload an image of the message. Additionally or alternatively, the user can be asked to provide a sample of handwriting that matches a preprinted text. For example, the user can be given a sample of text which he/she then handwrites and which is then converted into a font.

FIG. 2 moreover shows that the method 200 can include presenting 210 a final version of the gift card to the user for approval. That is, the design elements selected by the user can be combined into a final design and shown to the user to allow him/her to approve the final design. For example, the design can be shown electronically before the gift card is printed. Additionally or alternatively, the gift card can be printed and shown to the user for approval.

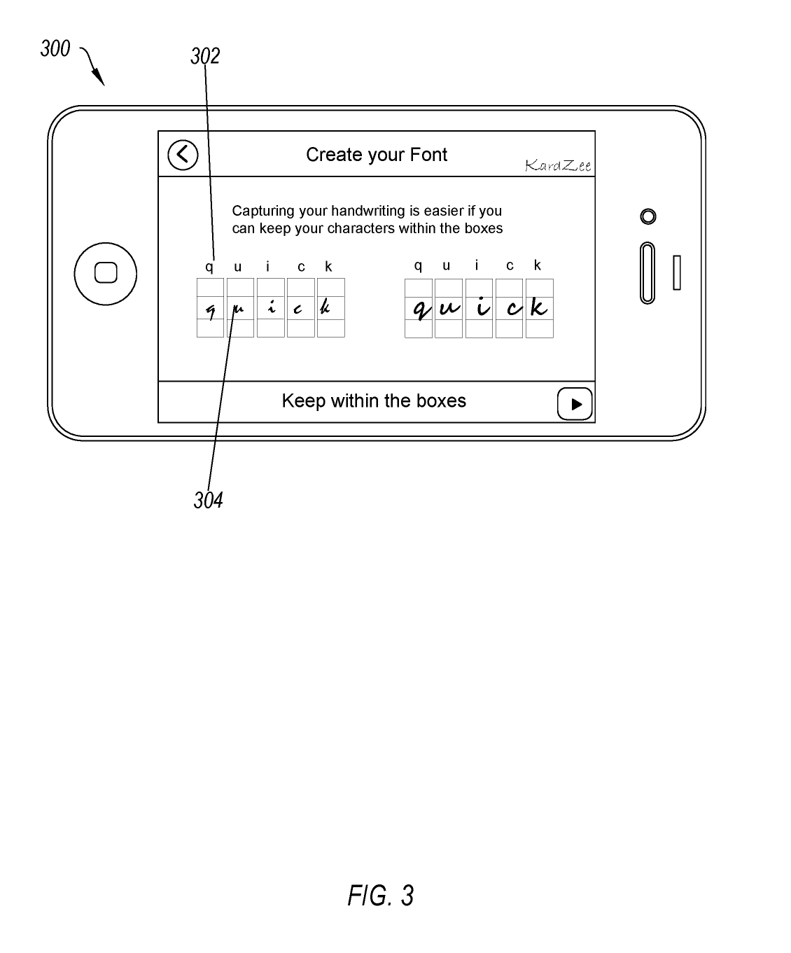

FIG. 3 illustrates an example of an interface 300 that allows a user to create a custom font from his/her handwriting. That is, the user can submit a handwriting sample that can be used to create a font that is similar to his/her handwriting.

FIG. 3 shows that the interface 300 can include sample text 302. The sample text 302 is text that the use will be asked to input. That is, the sample text is computer generated text that can be compared to the handwriting of the user to ensure that the interface 300 can correctly identify the characters input by the user.

FIG. 3 also shows that the interface 300 can include an input 304. The input 304 allows the user to input the text for matching to the sample text. The input can be a touchscreen interface that allows for creation of the individual characters or can include a mechanism that allows a user to align scanned text with the sample text.

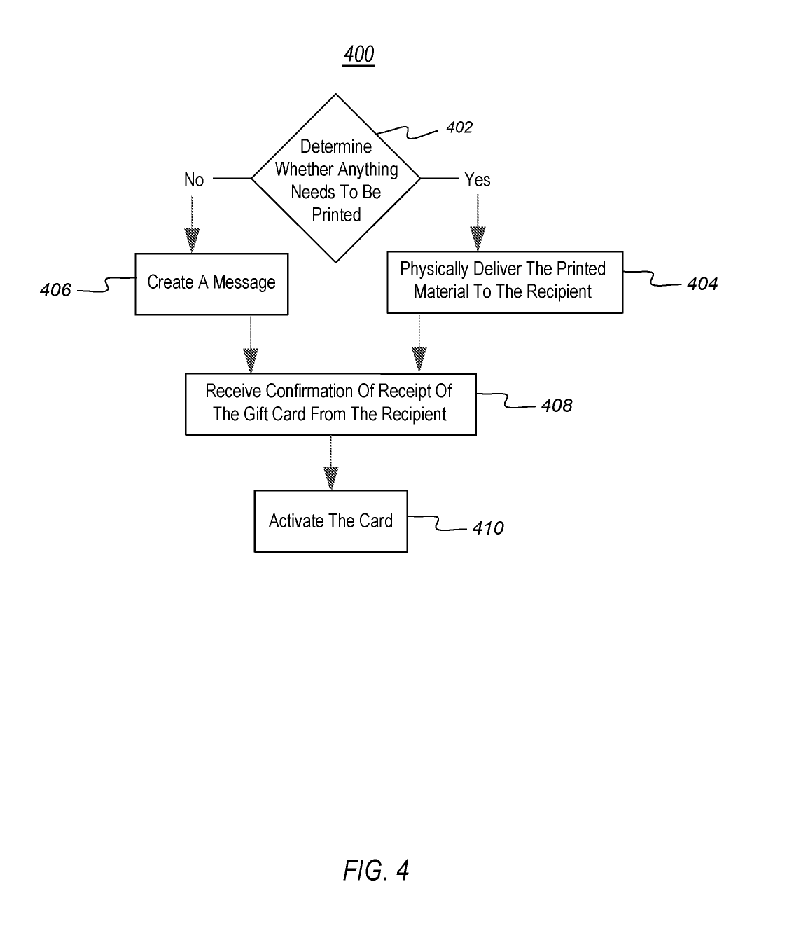

FIG. 4 is a flowchart illustrating a method 400 of delivering a completed card to a recipient. I.e., the method 400 is the process by which the recipient of the card can receive either the physical card or electronic card and/or allow a user to select the desired deliver method.

FIG. 4 shows that the method 400 can include determining 402 whether anything needs to be printed. For example, if the user wishes for the recipient to receive a physical card then the physical card must be printed onto a blank card or card stock. Likewise, the user may select a greeting card or post card on which a message or other information is printed.

FIG. 4 also shows that the method 400 can include physically delivering 404 the printed material to the recipient. For example, the gift card can be mailed to the recipient, can be handed by an employee to a recipient who is physically present or otherwise given to the recipient. Additionally or alternatively, the card can be given to the user if he she wishes to give the card to the recipient. Likewise, if a postcard is printed the postcard can be mailed to the recipient or given to the user for delivery to the recipient.

FIG. 4 further shows that the method 400 can include creating 406 a message if nothing is to be printed. The message can be sent through an app, via email, via text, via social media or can be any other message that will allow the recipient to redeem the gift card. The message can include information about the gift card and instructions on how to activate the gift card, if required.

FIG. 4 additionally shows that the method 400 can include receiving 408 confirmation of receipt of the card from the recipient. I.e., recipient confirms that he/she is in possession of the card. The confirmation process can be sent with the card or in a separate message. E.g., the actual card can be printed and mailed while confirmation instructions are emailed to the user. For example, the confirmation can include a message from an app that a QR code has been scanned, a dot pattern has been scanned, a correct answer(s) has been given to security questions about the recipient, a postcard has been scanned, an activation link has been loaded, an activation text has been received or any other message that indicates successful receipt of the gift card by the recipient.

FIG. 4 additionally shows that the method 400 can include activating 410 the gift card. Activating 410 includes sending the required information to systems which will allow the gift card to be redeemed. For example, activating 410 can include sending an appropriate electronic message to the retailer which will allow their payment method to accept the gift card as payment. Alternatively, if the gift card represents a gift then activating 410 the gift card can include a message to the retailer that the gift should be delivered or held for the recipient. One of skill in the art will appreciate that only after the gift card has been finalized and paid for is the gift card activated 410 in order to avoid fraudulent use of the gift card. One of skill in the art will further appreciate that activating 410 the gift card may be delayed until after confirmation is received 408 from the recipient that the gift card has been received to allow for fraud prevention.

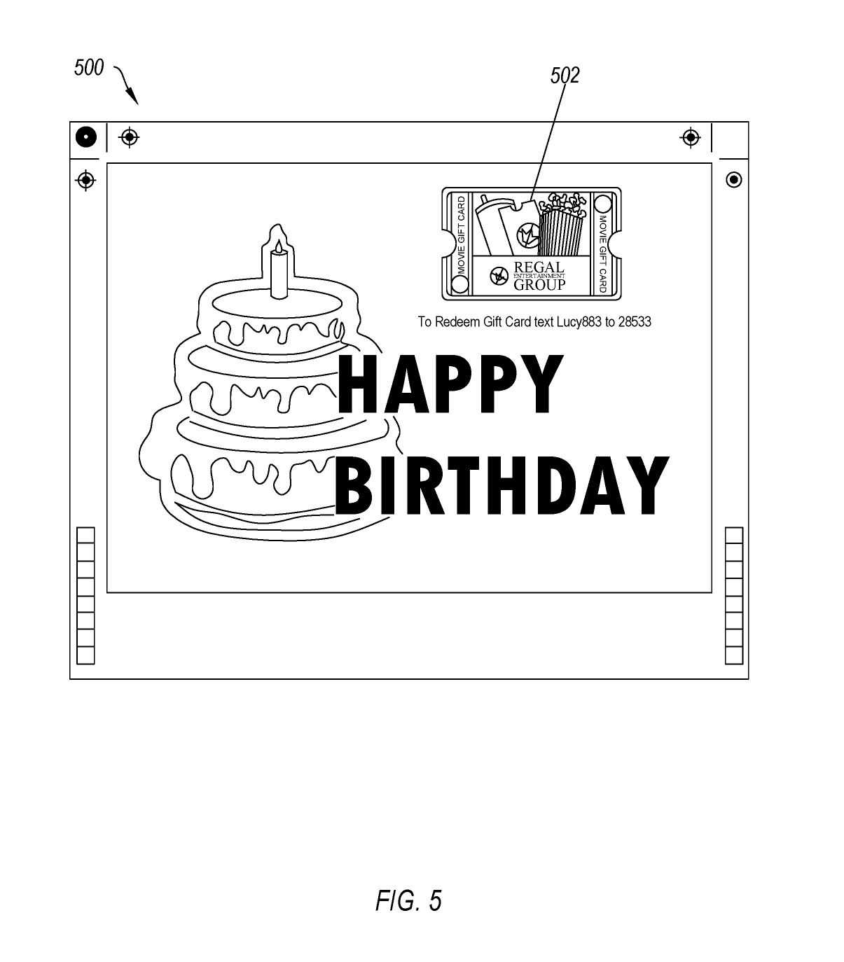

FIG. 5 illustrates an example of a personalized postcard 500 with an embedded gift card 502. The personalized postcard 500 can be designed and decorated by a user and sent to a recipient, either after delivery to the user or sent directly to the user.

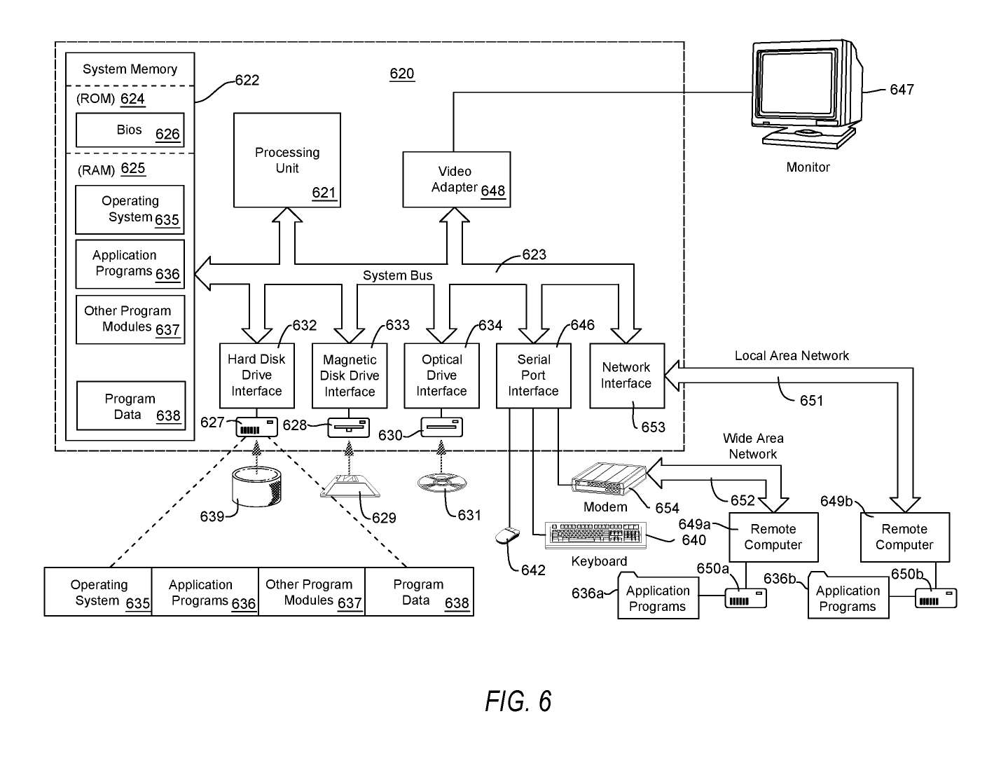

FIG. 6, and the following discussion, are intended to provide a brief, general description of a suitable computing environment in which the invention may be implemented. Although not required, the invention will be described in the general context of computer-executable instructions, such as program modules, being executed by computers in network environments. Generally, program modules include routines, programs, objects, components, data structures, etc. that performs particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

One of skill in the art will appreciate that the invention may be practiced in network computing environments with many types of computer system configurations, including personal computers, hand-held devices, mobile phones, multi-processor systems, microprocessor-based or programmable consumer electronics, network PCs, minicomputers, mainframe computers, and the like. The invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

With reference to FIG. 6, an example system for implementing the invention includes a general purpose computing device in the form of a conventional computer 620, including a processing unit 621, a system memory 622, and a system bus 623 that couples various system components including the system memory 622 to the processing unit 621. It should be noted however, that as mobile phones become more sophisticated, mobile phones are beginning to incorporate many of the components illustrated for conventional computer 620. Accordingly, with relatively minor adjustments, mostly with respect to input/output devices, the description of conventional computer 620 applies equally to mobile phones. The system bus 623 may be any of several types of bus structures including a memory bus or memory controller, a peripheral bus, and a local bus using any of a variety of bus architectures. The system memory includes read only memory (ROM) 624 and random access memory (RAM) 625. A basic input/output system (BIOS) 626, containing the basic routines that help transfer information between elements within the computer 620, such as during start-up, may be stored in ROM 624.

The computer 620 may also include a magnetic hard disk drive 627 for reading from and writing to a magnetic hard disk 639, a magnetic disk drive 628 for reading from or writing to a removable magnetic disk 629, and an optical disc drive 630 for reading from or writing to removable optical disc 631 such as a CD-ROM or other optical media. The magnetic hard disk drive 627, magnetic disk drive 628, and optical disc drive 630 are connected to the system bus 623 by a hard disk drive interface 632, a magnetic disk drive-interface 633, and an optical drive interface 634, respectively. The drives and their associated computer-readable media provide nonvolatile storage of computer-executable instructions, data structures, program modules and other data for the computer 620. Although the exemplary environment described herein employs a magnetic hard disk 639, a removable magnetic disk 629 and a removable optical disc 631, other types of computer readable media for storing data can be used, including magnetic cassettes, flash memory cards, digital versatile discs, Bernoulli cartridges, RAMs, ROMs, and the like.

Program code means comprising one or more program modules may be stored on the hard disk 639, magnetic disk 629, optical disc 631, ROM 624 or RAM 625, including an operating system 635, one or more application programs 636, other program modules 637, and program data 638. A user may enter commands and information into the computer 620 through keyboard 640, pointing device 642, or other input devices (not shown), such as a microphone, joy stick, game pad, satellite dish, scanner, motion detectors or the like. These and other input devices are often connected to the processing unit 621 through a serial port interface 646 coupled to system bus 623. Alternatively, the input devices may be connected by other interfaces, such as a parallel port, a game port or a universal serial bus (USB). A monitor 647 or another display device is also connected to system bus 623 via an interface, such as video adapter 648. In addition to the monitor, personal computers typically include other peripheral output devices (not shown), such as speakers and printers.

The computer 620 may operate in a networked environment using logical connections to one or more remote computers, such as remote computers 649a and 649b. Remote computers 649a and 649b may each be another personal computer, a server, a router, a network PC, a peer device or other common network node, and typically include many or all of the elements described above relative to the computer 620, although only memory storage devices 650a and 650b and their associated application programs 636a and 636b have been illustrated in FIG. 6. The logical connections depicted in FIG. 6 include a local area network (LAN) 651 and a wide area network (WAN) 652 that are presented here by way of example and not limitation. Such networking environments are commonplace in office-wide or enterprise-wide computer networks, intranets and the Internet.

When used in a LAN networking environment, the computer 620 can be connected to the local network 651 through a network interface or adapter 653. When used in a WAN networking environment, the computer 620 may include a modem 654, a wireless link, or other means for establishing communications over the wide area network 652, such as the Internet. The modem 654, which may be internal or external, is connected to the system bus 623 via the serial port interface 646. In a networked environment, program modules depicted relative to the computer 620, or portions thereof, may be stored in the remote memory storage device. It will be appreciated that the network connections shown are exemplary and other means of establishing communications over wide area network 652 may be used.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method for producing a custom card, the method comprising:
allowing a user to select a gift card;
allowing a user to select a host card;
combining the host card and the gift card to create a card; and
delivering the card to a recipient.

2. The method of claim 1, wherein the gift card includes a set amount of credit to a selected retailer.

3. The method of claim 1, wherein the gift card includes a representation of a gift to be given to the recipient.

4. The method of claim 1, wherein the host card includes at least one of:
a greeting card; or
a postcard.

5. The method of claim 1, wherein delivering the card to the recipient includes physical delivery of the card.

6. The method of claim 1, wherein delivering the card to the recipient includes electronic delivery of the card.

7. The method of claim 1, wherein combining the host card and the gift card includes embedding the gift card in the host card.

8. A method for producing a custom card, the method comprising:
allowing a user to select a gift card;
allowing a user to select a host card;
combining the host card and the gift card to create a card;
receiving information about the user;
receiving information about a recipient;
creating a card ID for the card; and
delivering the card to the recipient.

9. The method of claim 8 further comprising:
determining if an ID number exists for the user;
creating an ID number for the user if one does not exist; and
retrieving an ID number for the user if one does exist.

10. The method of claim 9 further comprising:
associating the ID number for the user with the card ID.

11. The method of claim 8 further comprising:
determining if an ID number exists for the recipient;
creating an ID number for the recipient if one does not exist; and
retrieving an ID number for the recipient if one does exist.

12. The method of claim 11 further comprising:
associating the ID number for the recipient with the card ID.

13. The method of claim 8, wherein receiving information about the user includes at least one of:
the user's name;
the user's address;
the user's email address; or the user's phone number.

14. The method of claim 8, wherein receiving information about the recipient includes at least one of:
the recipient's name;
the recipient's address;
the recipient's email address; or
the recipient's phone number.

15. A method for producing a custom card, the method comprising:
allowing a user to select a gift card, wherein allowing the user to select the gift card includes:
receiving from the user the gift to be represented by the gift card;
receiving from the user a design for the gift card;
if the user wants a message to appear on the gift card:
receiving from the user a desired font;
allowing the user to select a host card, wherein allowing the user to select the host card includes:
receiving from the user a design for the host card;
if the user wants a message to appear on the host card:
receiving from the user a desired font;
combining the host card and the gift card to create a card;
receiving information about the user;
receiving information about a recipient;
presenting the card to the user for final approval;
creating a card ID for the card; and
delivering the card to the recipient.

16. The method of claim 15 if the desired font is a custom font:
receiving a sample from the user;
comparing the sample from the user to sample text;
creating the custom font.

17. The method of claim 15, wherein delivering a card to the recipient includes:
determining whether the card needs to be printed;
if the card needs to be printed:
creating the physical card; and
delivering the physical card to at least one of the user or the recipient;
if the card does not need to be printed:
creating a message to the recipient;
receiving confirmation of receipt of the card; and
activating the gift card.

18. The method of claim 15, wherein delivering the physical card includes mailing the physical card.

19. The method of claim 15, wherein receiving confirmation of receipt includes at least one of:
a message that a QR code has been scanned;
a message that a dot pattern has been scanned;
a message that a correct answer has been given to security questions about the recipient;
receiving a correct answer to security questions about the recipient;
a message that a postcard has been scanned;
a scan of a postcard;
a message that an activation link has been loaded; or
receiving an activation text.

20. The method of claim 15, wherein activating the gift card includes at least one of:
sending a message to a retailer payment system that the card has been activated; or
initiating delivery of a physical gift.
